(19) United States
(12) Patent Application Publication
(10) Pub. No.: US 2021/0312575 A1
(43) Pub. Date: Oct. 7, 2021

(54) METHOD AND APPARATUS FOR SELECTING CONSTRUCTION SCENARIO FOR REMODELING BUILDING FACADE

(71) Applicant: INDUSTRY-UNIVERSITY COOPERATION FOUNDATION HANYANG UNIVERSITY ERICA CAMPUS, Ansan-Si Gyeonggi-do (KR)

(72) Inventors: Sungho TAE, Ansan-Si Gyeonggi-do (KR); Rakhyun KIM, Ansan-Si Gyeonggi-do (KR); Hyojin LIM, Ansan-Si Gyeonggi-do (KR); Jonggeon LEE, Ansan-Si Gyeonggi-do (KR); Seung Jun ROH, Hwaseong-Si Gyeonggi-do (KR)

(21) Appl. No.: 17/278,502

(22) PCT Filed: Dec. 28, 2018
(86) PCT No.: PCT/KR2018/016833

§ 371 Date: Mar. 22, 2021

(30) Foreign Application Priority Data
Sep. 21, 2018 (KR) 10-2018-0113623
Dec. 20, 2018 (KR) 10-2018-0165809

(51) Int. Cl. G06Q 50/08; G06Q 10/06; G06Q 50/16; G06Q 30/00

(52) U.S. Cl. CPC G06Q 50/08; G06Q 10/067; G06Q 10/06313; G06Q 30/018; G06Q 10/06375; G06Q 50/165

(57) ABSTRACT

A method and an apparatus for selecting a construction scenario for remodeling a building facade are disclosed. A method for selecting a construction scenario for remodeling a building facade, according to an embodiment of the present invention, comprises the steps of: calculating a heat transmission coefficient value for each of a plurality of construction scenarios for remodeling a building facade; classifying, into candidate construction scenarios, construction scenarios of which the heat transmission coefficient value is greater than or equal to a reference value, from among the plurality of construction scenarios; calculating an environmental impact assessment value and an economic evaluation value for each of the candidate construction scenarios; and selecting, as a recommended construction scenario, at least one construction scenario among the candidate construction scenarios according to the environmental impact assessment values and the economic evaluation values.

### TECHNICAL FIELD

The present disclosure relates to a method and apparatus for selecting a construction scenario for remodeling a building envelope, and more particularly, to a method and apparatus for selecting a construction scenario for remodeling a building envelope capable of taking energy performance, economic feasibility, and environmental load into consideration for green remodeling.

### BACKGROUND ART

In recent years, with an increase in concerns about climate change at the global level, interest in environmental issues has led to specific agreements. In particular, the issue of global warming has been raised quite concretely, and because global warming affects the world, each country has not only made individual efforts to reduce greenhouse gas emissions but also conducted research to reduce greenhouse gas emissions globally in cooperation with other countries through international agreements.

Accordingly, various carbon-centered environmental policies to cope with climate change have been implemented, and the need to reduce environmental load due to industrial activities at the national level has arisen. Accordingly, the government has publicly announced Intended Nationally Determined Contributions (INDC), which is a voluntary environmental load reduction target, to prepare for a new climate change framework and has set a specific target to improve national energy efficiency by 40% by 2030. Environmental load emissions tend to be higher in the building sector than in the industrial sector in countries, such as South Korea, in which industrialization is completed. Currently, environmental load due to building energy consumption is in a gradually increasing trend, and energy savings is not only required for newly-constructed buildings but also required for existing buildings that account for 70% of total number of buildings. Buildings consume a large amount of energy throughout the entire process. When energy input in a building material production step and a building operation step is taken into account, energy consumption of buildings account for 37% of total annual energy consumption in South Korea. Energy consumed by multi-unit dwellings, which are typical residential buildings, accounts for a very large proportion of the annual energy consumption of buildings throughout the entire process. That is, the energy consumed by multi-unit dwellings accounts for about 40% of annual energy consumption of buildings. Energy consumption of multi-unit dwellings occurs through an envelope system that comes in direct contact with outside air. Improvement in performance of an old envelope system is essential for improvement of energy efficiency of multi-unit dwellings through green remodeling.

### DISCLOSURE

### Technical Problem

The present disclosure is directed to providing a method and apparatus for selecting a construction scenario for remodeling a building envelope capable of selecting a construction scenario that is highly energy-efficient and economically feasible and is eco-friendly in remodeling a building envelope that consists of exterior walls, windows, and the like of a building.

### Technical Solution

According to an embodiment of the present disclosure, a method for selecting a construction scenario for remodeling a building envelope includes calculating a heat transmission coefficient value for each of a plurality of construction scenarios relating to remodeling of a building envelope, classifying construction scenarios in which the heat transmission coefficient value is greater than or equal to a reference value among the plurality of construction scenarios as candidate construction scenarios, calculating an environmental impact assessment value and an economic feasibility evaluation value for each of the candidate construction scenarios, and selecting at least one of the candidate construction scenarios as a recommended construction scenario according to the environmental impact assessment value and the economic feasibility evaluation value.

Each of the plurality of construction scenarios may include a construction method and input material information.

The construction method may be a replacement construction method in which an existing envelope is replaced with a new envelope or an add-on construction method in which an additional envelope is constructed on the existing envelope.

The reference value may be determined by the location of the building in accordance with regional heat transmission coefficient standards.

The heat transmission coefficient value may be calculated according to a mathematical equation, and the mathematical equation may be

$${k}_{m} = \frac{{k}_{f} \times {F}_{f} + {k}_{w} \times {F}_{w}}{{F}_{f} + {F}_{w}} ,$$

where kₘ represents the heat transmission coefficient value, k_{f} represents a heat transmission coefficient value of an exterior wall portion, F_{f} represents an area of the exterior wall portion, k_{w} represents a heat transmission coefficient value of a window portion, and F_{w} represents an area of the window portion.

The environmental impact assessment value may include at least any one of a global warming impact value, a resource depletion impact value, an acidification impact value, a eutrophication impact value, an ozone depletion impact value, and a photochemical oxidation impact value that relate to input materials.

The economic feasibility evaluation value may be calculated on the basis of at least any one of a unit cost of input materials, a construction waste disposal cost, and a construction cost.

According to an embodiment of the present disclosure, an apparatus for selecting a construction scenario for remodeling a building envelope includes an energy performance evaluation unit configured to calculate a heat transmission coefficient value for each of a plurality of construction scenarios relating to remodeling of a building envelope and configured to classify construction scenarios in which the heat transmission coefficient value is greater than or equal to a reference value among the plurality of construction scenarios as candidate construction scenarios, an environmental impact assessment unit configured to calculate an environmental impact assessment value for each of the candidate construction scenarios, an economic feasibility evaluation unit configured to calculate an economic feasibility evaluation value for each of the candidate construction scenarios, and a recommended construction scenario selection unit configured to select at least one of the candidate construction scenarios as a recommended construction scenario according to the environmental impact assessment value and the economic feasibility evaluation value.

Each of the plurality of construction scenarios may include a construction method and input material information.

The construction method may be a replacement construction method in which an existing envelope is replaced with a new envelope or an add-on construction method in which an additional envelope is constructed on the existing envelope.

The energy performance evaluation unit may determine a value corresponding to the location of the building among regional heat transmission coefficient reference values as the reference value.

The energy performance evaluation unit may calculate the heat transmission coefficient value according to a mathematical equation, and the mathematical equation may be

$${k}_{m} = \frac{{k}_{f} \times {F}_{f} + {k}_{w} \times {F}_{w}}{{F}_{f} + {F}_{w}} ,$$

where kₘ represents the heat transmission coefficient value, k_{f} represents a heat transmission coefficient value of an exterior wall portion, F_{f} represents an area of the exterior wall portion, k_{w} represents a heat transmission coefficient value of a window portion, and F_{w} represents an area of the window portion.

The environmental impact assessment unit may calculate the environmental impact assessment value on the basis of at least any one of a global warming impact value, a resource depletion impact value, an acidification impact value, a eutrophication impact value, an ozone depletion impact value, and a photochemical oxidation impact value that relate to input materials.

The economic feasibility evaluation unit may calculate the economic feasibility evaluation value on the basis of at least any one of a unit cost of input materials, a construction waste disposal cost, and a construction cost.

The recommended construction scenario selection unit may select a recommended construction scenario on the basis of the weighted sum of the heat transmission coefficient value, the environmental impact assessment value and the economic feasibility evaluation value.

The recommended construction scenario selection unit may select the recommended construction scenario on the basis of any one of the heat transmission coefficient value, the environmental impact assessment value, and the economic feasibility evaluation value according to an order of priority determined by a user.

### Advantageous Effects

According to an embodiment of the present disclosure, a method and apparatus for selecting a construction scenario for remodeling a building envelope can suggest recommended construction scenarios that satisfy energy performance and are highly economically feasible and eco-friendly even when a user just enters simple information in remodeling a building envelope.

### DESCRIPTION OF DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a construction scenario selection apparatus for remodeling a building envelope according to an embodiment of the present disclosure;

FIG. 2 is a flowchart for describing the operation of the construction scenario selection apparatus for remodeling a building envelope that is illustrated in FIG. 1;

FIG. 3 is a flowchart for describing the operation of an energy performance evaluation unit illustrated in FIG. 1;

FIGS. 4 and 5 illustrate examples of an input screen through which a user may input information on a building envelope to the construction scenario selection apparatus illustrated in FIG. 1; and

FIG. 6 illustrates an example of a screen showing a result of the construction scenario selection apparatus illustrated in FIG. 1 selecting recommended construction scenarios.

### MODE FOR INVENTION

Specific structural or functional descriptions relating to embodiments according to the concept of the present disclosure are only provided for the purpose of describing the embodiments according to the concept of the present disclosure. The embodiments according to the concept of the present disclosure may be embodied in various forms and are not limited to the embodiments described herein.

Since various modifications may be made to the embodiments according to the concept of the present disclosure and the present disclosure may have various forms, specific embodiments will be illustrated in the drawings and described in detail herein. However, this does not limit the present disclosure to the specific forms disclosed herein, and all modifications, equivalents, and substitutes included in the spirit and scope of the present disclosure belong to the present disclosure.

Terms including ordinals such as first and second may be used to describe various elements, but the elements are not limited by the terms. The terms are only used for the purpose of distinguishing one element from another element. For example, a first element may be referred to as a second element without departing from the scope according to the concept of the present disclosure, and likewise, a second element may also be referred to as a first element.

When it is mentioned that a certain element is “connected” or “linked” to another element, although the certain element may be directly connected or linked to the other element, it should be understood that another element may be present therebetween. On the other hand, when it is mentioned that a certain element is “directly connected” or “directly linked” to another element, it should be understood that other elements are not present therebetween. Other expressions used to describe a relationship between elements, i.e., “between” and “directly between” or “adjacent” and “directly adjacent,” should be interpreted likewise.

Terms used in the present specification are only used to describe specific embodiments and are not intended to limit the present disclosure. A singular expression includes a plural expression unless the context clearly indicates otherwise. In the specification, terms such as “include” or “have” should be understood as designating that features, number, steps, operations, elements, parts, or combinations thereof are present and not as precluding the possibility of the presence or addition of one or more other features, numbers, steps, operations, elements, parts, or combinations thereof in advance.

Unless otherwise defined, all terms including technical or scientific terms used herein have the same meaning as commonly understood by those of ordinary skill in the art to which the present disclosure pertains. Terms, such as those defined in commonly used dictionaries, should be construed as having a meaning that is consistent with their meaning in the context of the relevant art and are not to be construed in an idealized or overly formal sense unless expressly so defined herein.

Hereinafter, exemplary embodiments of the present disclosure will be described in detail with reference to the accompanying drawings.

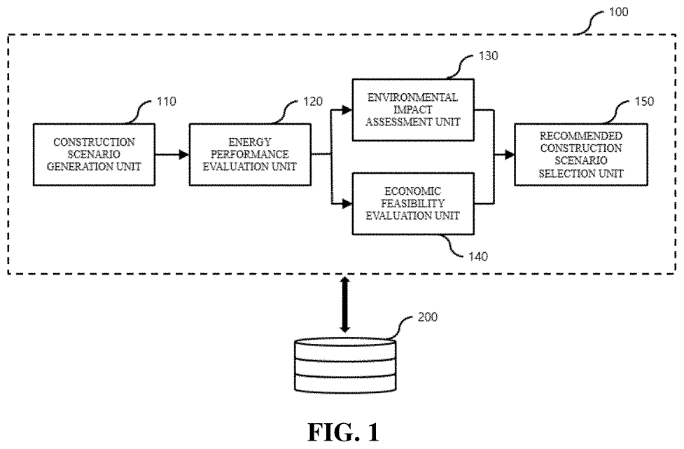

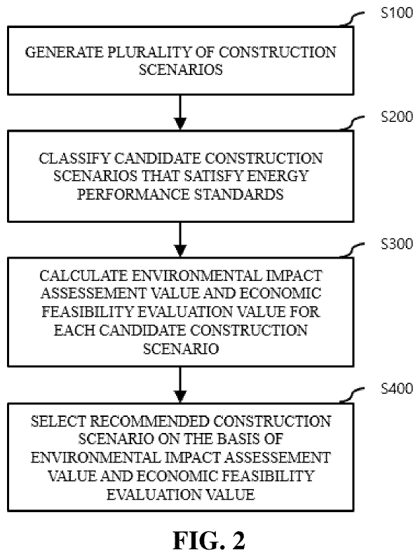

FIG. 1 is a block diagram illustrating a construction scenario selection apparatus for remodeling a building envelope according to an embodiment of the present disclosure, and FIG. 2 is a flowchart for describing the operation of the construction scenario selection apparatus for remodeling a building envelope that is illustrated in FIG. 1.

Referring to FIGS. 1 and 2, a construction scenario selection apparatus 100 may include a construction scenario generation unit 110, an energy performance evaluation unit 120, an environmental impact assessment unit 130, an economic feasibility evaluation unit 140, and a recommended construction scenario selection unit 150.

Although a database 200 is illustrated in FIG. 1 as being separately configured from the construction scenario selection apparatus 100, this is merely an embodiment for convenience of description, and various modifications are possible. For example, the construction scenario selection apparatus 100 may include the database 200.

The construction scenario generation unit 110 generates a plurality of construction scenarios according to information input by a user (S100). When a user inputs pieces of information on a building, e.g., location information, the structure and area of exterior walls, the structure and area of windows, and the like, the construction scenario selection apparatus 100 generates a plurality of construction scenarios that are possible in relation to the pieces of information.

The plurality of construction scenarios may each include a construction method and input material information. The construction method may be a replacement construction method in which an existing envelope of a building is replaced with a new envelope or an add-on construction method in which an additional envelope is constructed while the existing envelope of the building is maintained. The input material information relates to types of input materials.

For example, in a case in which existing exterior walls for internal insulation consist of concrete, T50 mineral wool, plasterboard, and wallpaper, the construction scenario generation unit 110 may generate the plurality of construction scenarios using an add-on construction method in which extruded polystyrene (XPS), plasterboard, and wallpaper are added to the existing exterior walls for internal insulation, a replacement construction method in which the T50 mineral wool and plasterboard of the existing exterior walls for internal insulation are removed and grey expanded polystyrene (EPS), plasterboard, and wallpaper are newly added, or a replacement construction method in which the T50 mineral wool and plasterboard of the existing exterior walls for internal insulation are removed and grey EPS, plasterboard, wallpaper, insulation mortar, and water-based paint are newly added.

According to an embodiment, the construction scenario generation unit 110 may load the plurality of construction scenarios, which are stored in the database 200, from the database 200.

According to another embodiment, types of input materials may be stored in the database 200, and the construction scenario generation unit 110 may combine the input materials to generate a plurality of construction scenarios.

The construction scenario generation unit 110 may generate the plurality of construction scenarios so that input materials or construction methods not desired by a user are not included.

The energy performance evaluation unit 120 evaluates energy performance for each of the plurality of construction scenarios generated by the construction scenario generation unit 110 and classifies construction scenarios in which the evaluated energy performance satisfies predetermined energy performance standards as candidate construction scenarios (S200).

According to an embodiment, the energy performance evaluation unit 120 may evaluate energy performance for each orientation of the building and select candidate construction scenarios according to an evaluation result.

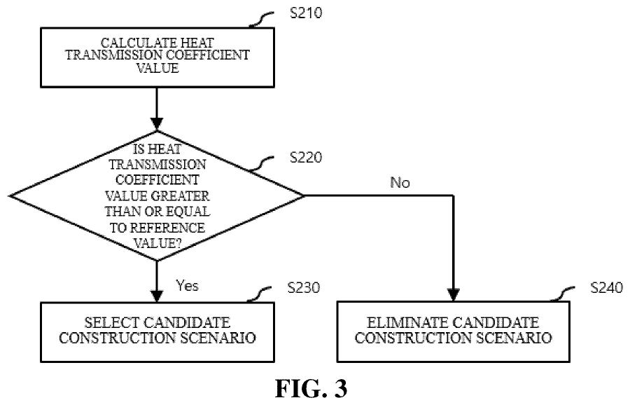

The operation of the energy performance evaluation unit 120 will be described in more detail with reference to FIG. 3. FIG. 3 is a flowchart for describing the operation of the energy performance evaluation unit illustrated in FIG. 1. Referring to FIG. 3, the energy performance evaluation unit 120 calculates a heat transmission coefficient value for each of the plurality of construction scenarios (S210). The energy performance evaluation unit 120 calculates the heat transmission coefficient value by obtaining a weighted average of a heat transmission coefficient value of a window portion and a heat transmission coefficient value of an exterior wall portion. For example, the energy performance evaluation unit 120 calculates the heat transmission coefficient value according to Mathematical Equation 1 below.

$${k}_{m} = \frac{{k}_{f} \times {F}_{f} + {k}_{w} \times {F}_{w}}{{F}_{f} + {F}_{w}} \qquad [ Mathematical Equation 1 ]$$

Here, kₘ represents the heat transmission coefficient value, k_{f} represents a heat transmission coefficient value of an exterior wall portion, F_{f} represents an area of the exterior wall portion, k_{w} represents a heat transmission coefficient value of a window portion, and F_{w} represents an area of the window portion.

The energy performance evaluation unit 120 may calculate the heat transmission coefficient value of the exterior wall portion on the basis of a heat resistance value of each material input to the exterior wall portion. Also, the energy performance evaluation unit 120 may calculate the heat transmission coefficient value of the window portion on the basis of a heat resistance value of each material input to the window portion. The heat resistance values of the input materials may be stored in the database 200.

For example, the energy performance evaluation unit 120 may calculate the heat transmission coefficient value of the exterior wall portion and the heat transmission coefficient value of the window portion according to Mathematical Equation 2 below.

$$U = \frac{1}{{R}_{i} + \sum {a}_{n} + {R}_{o}} \qquad [ Mathematical Equation 2 ]$$

Here, U represents a heat transmission coefficient value of an exterior wall portion or a heat transmission coefficient value of a window portion (W/m²K), Rᵢ represents indoor surface heat transfer resistance (m²K/W), Rₒ represents outdoor surface heat transfer resistance (m²K/W), and aₙ represents the heat resistance of input materials (m²K/W).

The energy performance evaluation unit 120 compares the calculated heat transmission coefficient values with a reference value (S220). The reference value may be determined by the location of the building in accordance with regional heat transmission coefficient standards. The regional heat transmission coefficient standards may be stored in the database 200. For example, the regional heat transmission coefficient standards may be Korean Standards (KS) or building energy saving design standards set by the Korea Energy Management Corporation.

In a case in which the calculated heat transmission coefficient values are greater than or equal to the reference value (“Yes” branch from S220), the energy performance evaluation unit 120 selects the corresponding construction scenarios as the candidate construction scenarios (S230). Conversely, in a case in which the calculated heat transmission coefficient values are less than the reference value (“No” branch from S220), the energy performance evaluation unit 120 does not select the corresponding construction scenarios as the candidate construction scenarios (S240).

According to an embodiment, the energy performance evaluation unit 120 may calculate heat transmission coefficient values for each orientation of the building. For example, the energy performance evaluation unit 120 may calculate heat transmission coefficient values for a front portion, a rear portion, and side portions of the building and may, in a case in which all of the calculated heat transmission coefficient values are greater than or equal to the reference value, select the corresponding construction scenarios as the candidate construction scenarios.

The environmental impact assessment unit 130 calculates environmental impact assessment values for the candidate construction scenarios, and the economic feasibility evaluation unit 140 calculates economic feasibility evaluation values for the candidate construction scenarios (S300).

The environmental impact assessment unit 130 loads at least one environmental impact value of the input materials from the database 200 and calculates the environmental impact assessment values on the basis of the at least one loaded environmental impact value.

For example, environmental impact values of each input material that relate to six environmental impact categories including global warming, resource depletion, acidification, eutrophication, ozone depletion, and photochemical oxidation may be stored in the database 200. The environmental impact assessment unit 130 calculates the environmental impact assessment values on the basis of at least one of a global warming impact value, a resource depletion impact value, an acidification impact value, a eutrophication impact value, an ozone depletion impact value, and a photochemical oxidation impact value that relate to input materials of construction scenarios to be evaluated. For example, the environmental impact assessment unit 130 may calculate a weighted sum of the impact values and determine the weighted sum as the environmental impact assessment value. The weight in the weighted sum may be determined by the user.

The environmental impact assessment unit 130 may calculate the environmental impact assessment value also in consideration of environmental impact values of removed materials, that is, construction waste. For example, the environmental impact assessment unit 130 may, when calculating environmental impact assessment values relating to construction scenarios in which a replacement construction method is used, reflect environmental impact values of removed materials in addition to environmental impact values of input materials.

The economic feasibility evaluation unit 140 loads at least one of a unit cost of input materials, a construction waste disposal cost, and a construction cost from the database 200 and calculates an economic feasibility evaluation value on the basis of the loaded value. The unit cost of input materials, construction cost, and cost for disposal of removed materials may be stored in the database 200.

The recommended construction scenario selection unit 150 selects recommended construction scenarios among the candidate construction scenarios on the basis of at least one of the energy performance evaluation values, environmental impact assessment values, and economic feasibility evaluation values (S400).

According to an embodiment, the recommended construction scenario selection unit 150 may select some of the candidate construction scenarios as recommended construction scenarios on the basis of the weighted average or weighted sum of the heat transmission coefficient values, environmental impact assessment values, and economic feasibility evaluation values.

According to another embodiment, the recommended construction scenario selection unit 150 may select recommended construction scenarios on the basis of at least one of the heat transmission coefficient values, environmental impact assessment values, and economic feasibility evaluation values according to an order of priority determined by the user.

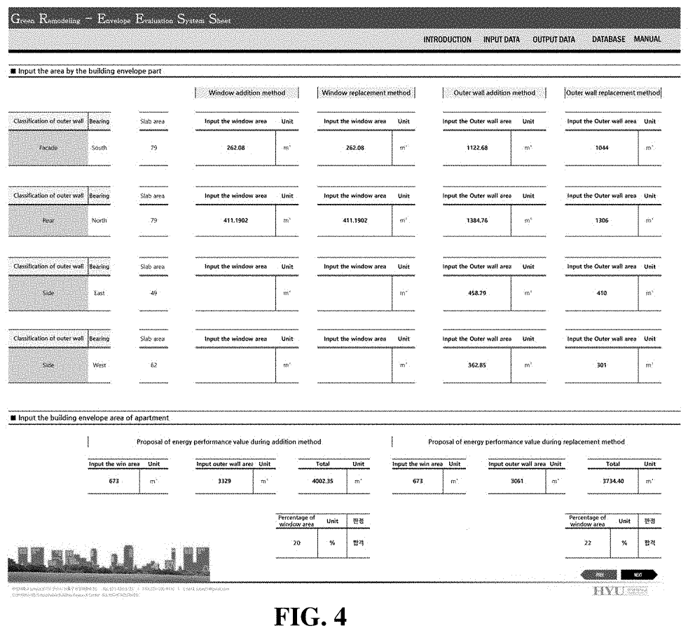

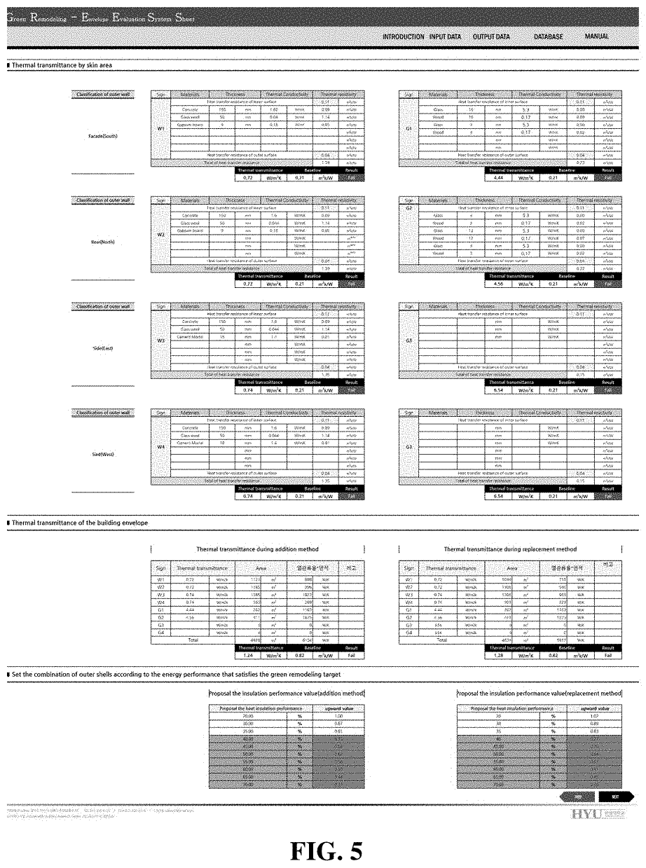

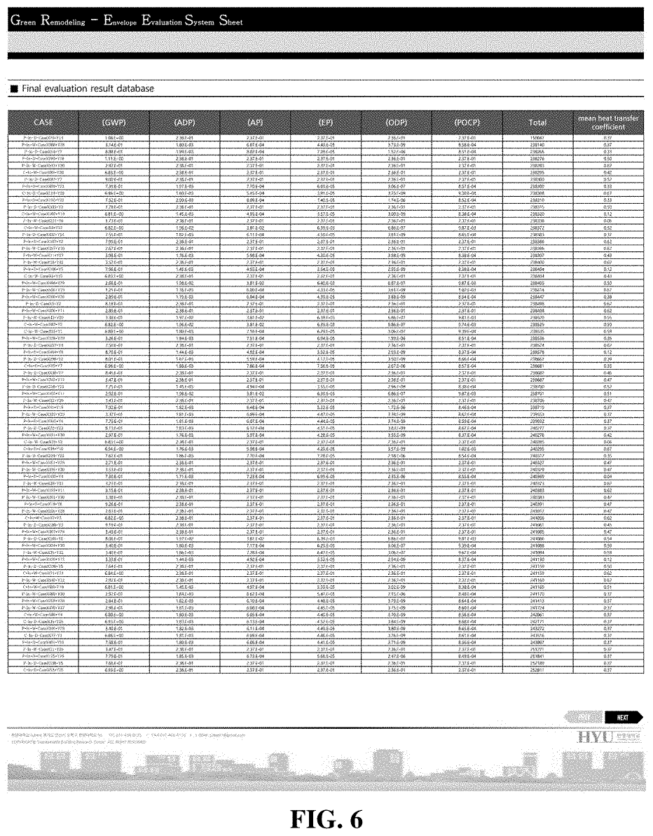

FIGS. 4 and 5 illustrate examples of an input screen through which the user may input information on a building envelope to the construction scenario selection apparatus illustrated in FIG. 1, and FIG. 6 illustrates an example of a screen showing a result of the construction scenario selection apparatus illustrated in FIG. 1 selecting recommended construction scenarios.

Referring to FIGS. 4 to 6, the construction scenario selection apparatus 100 may provide an input screen illustrated in FIG. 4 or 5 through which the user may input information on the building. When the user inputs information on the building, e.g., the area and structure of exterior walls and the area and structure of windows of the building envelope, the construction scenario selection apparatus 100 performs a construction scenario selection process. Here, the information being input may be classified for each orientation of the building.

The construction scenario selection apparatus 100 may generate a plurality of construction scenarios corresponding to the input information, may load data relating to a construction method and input materials of each of the plurality of generated construction scenarios from the database 200, and may perform energy performance evaluation, environmental impact assessment, and economic feasibility evaluation on the basis of the loaded data.

The construction scenario selection apparatus 100 may output recommended construction scenarios as illustrated in FIG. 6 according to an evaluation result. Here, a ranking of the recommended construction scenarios may be determined on the basis of the weighted average or weighted sum of the energy performance evaluation result, environmental impact assessment result, and economic feasibility evaluation result or determined according to standards set by the user.

The present disclosure has been described above with reference to the embodiments illustrated in the drawings, but the embodiments are merely illustrative, and those or ordinary skill in the art should understand that various modifications and other equivalent embodiments are possible. Therefore, the actual technical scope of the present disclosure should be defined by the technical spirit of the appended claims.

### EXPLANATION OF REFERENCE NUMERALS

100: Construction Scenario Selection Apparatus

110: Construction Scenario Generation Unit

120: Energy Performance Evaluation Unit

130: Environmental Impact Assessment Unit

140: Economic Feasibility Evaluation Unit

150: Recommended Construction Scenario Selection Unit

1. A method for selecting a construction scenario for remodeling a building envelope performed by an apparatus for selecting the construction scenario for remodeling the building envelope, the method comprising:
calculating a heat transmission coefficient value for each of a plurality of construction scenarios relating to remodeling of a building envelope;
classifying construction scenarios in which the heat transmission coefficient value is greater than or equal to a reference value among the plurality of construction scenarios as candidate construction scenarios;
calculating an environmental impact assessment value and an economic feasibility evaluation value for each of the candidate construction scenarios; and
selecting at least one of the candidate construction scenarios as a recommended construction scenario according to the environmental impact assessment value and the economic feasibility evaluation value,
wherein each of the plurality of construction scenarios includes a construction method and input materials,
wherein the construction method is a replacement construction method in which an existing envelope is replaced with a new envelope or an add-on construction method in which an additional envelope is constructed on the existing envelope, and
wherein the environmental impact assessment value is calculated in consideration of environmental impact values of removed materials in the existing envelope and the economic feasibility evaluation value is calculated in consideration of cost for disposal of the removed materials when the construction method is the replacement construction method.

2. (canceled)

3. (canceled)

4. The method of claim 1, wherein the reference value is determined by the location of the building in accordance with regional heat transmission coefficient standards.

5. The method of claim 1, wherein the heat transmission coefficient value is calculated according to a mathematical equation, and
the mathematical equation is
$${k}_{m} = \frac{{k}_{f} \times {F}_{f} + {k}_{w} \times {F}_{w}}{{F}_{f} + {F}_{w}} ,$$
where kₘ represents the heat transmission coefficient value, k_{f} represents a heat transmission coefficient value of an exterior wall portion, F_{f} represents an area of the exterior wall portion, k_{w} represents a heat transmission coefficient value of a window portion, and F_{w} represents an area of the window portion.

6. The method of claim 1, wherein the environmental impact assessment value includes at least any one of a global warming impact value, a resource depletion impact value, an acidification impact value, a eutrophication impact value, an ozone depletion impact value, and a photochemical oxidation impact value that relate to input materials.

7. The method of claim 1, wherein the economic feasibility evaluation value is calculated on the basis of at least any one of a unit cost of input materials, a construction waste disposal cost, and a construction cost.

8. An apparatus for selecting a construction scenario for remodeling a building envelope, the apparatus comprising:
an energy performance evaluation unit configured to calculate a heat transmission coefficient value for each of a plurality of construction scenarios relating to remodeling of a building envelope and configured to classify construction scenarios in which the heat transmission coefficient value is greater than or equal to a reference value among the plurality of construction scenarios as candidate construction scenarios;
an environmental impact assessment unit configured to calculate an environmental impact assessment value for each of the candidate construction scenarios;
an economic feasibility evaluation unit configured to calculate an economic feasibility evaluation value for each of the candidate construction scenarios; and
a recommended construction scenario selection unit configured to select at least one of the candidate construction scenarios as a recommended construction scenario according to the environmental impact assessment value and the economic feasibility evaluation value,
wherein each of the plurality of construction scenarios includes a construction method and input materials,
wherein the construction method is a replacement construction method in which an existing envelope is replaced with a new envelope or an add-on construction method in which an additional envelope is constructed on the existing envelope, and
wherein the environmental impact assessment unit calculates the environmental impact assessment value in consideration of environmental impact values of removed materials in the existing envelope and the economic feasibility evaluation unit calculates the economic feasibility evaluation value in consideration of cost for disposal of the removed materials when the construction method is the replacement construction method.

9. (canceled)

10. (canceled)

11. The apparatus of claim 8, wherein the energy performance evaluation unit determines a value corresponding to the location of the building among regional heat transmission coefficient reference values as the reference value.

12. The apparatus of claim 8, wherein the energy performance evaluation unit calculates the heat transmission coefficient value according to a mathematical equation, and
the mathematical equation is
$${k}_{m} = \frac{{k}_{f} \times {F}_{f} + {k}_{w} \times {F}_{w}}{{F}_{f} + {F}_{w}} ,$$
where kₘ represents the heat transmission coefficient value, k_{f} represents a heat transmission coefficient value of an exterior wall portion, F_{f} represents an area of the exterior wall portion, k_{w} represents a heat transmission coefficient value of a window portion, and F_{w} represents an area of the window portion.

13. The apparatus of claim 8, wherein the environmental impact assessment unit calculates the environmental impact assessment value on the basis of at least any one of a global warming impact value, a resource depletion impact value, an acidification impact value, a eutrophication impact value, an ozone depletion impact value, and a photochemical oxidation impact value that relate to input materials.

14. The apparatus of claim 8, wherein the economic feasibility evaluation unit calculates the economic feasibility evaluation value on the basis of at least any one of a unit cost of input materials, a construction waste disposal cost, and a construction cost.

15. The apparatus of claim 8, wherein the recommended construction scenario selection unit selects a recommended construction scenario on the basis of the weighted sum of the heat transmission coefficient value, the environmental impact assessment value and the economic feasibility evaluation value.

16. The apparatus of claim 8, wherein the recommended construction scenario selection unit selects the recommended construction scenario on the basis of any one of the heat transmission coefficient value, the environmental impact assessment value, and the economic feasibility evaluation value according to an order of priority determined by a user.
